(19) United States
(12) Patent Application Publication
(10) Pub. No.: US 2020/0387941 A1
(43) Pub. Date: Dec. 10, 2020

(54) SYSTEMS AND METHODS FOR FACILITATING EMERGENCY RELIEF DONATIONS

(71) Applicant: Wells Fargo Bank, N.A., San Francisco, CA (US)

(72) Inventors: Mary E. Gassel, San Francisco, CA (US); Jesse Lee, Dublin, CA (US); John Penacerrada, Brentwood, CA (US)

(21) Appl. No.: 14/816,881

(22) Filed: Aug. 3, 2015

(51) Int. Cl. G06Q 30/02; G06Q 20/10

(52) U.S. Cl. CPC G06Q 30/0279; G06Q 20/108

(57) ABSTRACT

A computer-implemented method for facilitating an emergency relief donation includes receiving, by a financial institution computer system, a donation pledge from a donor to send funds to a donee from a payment account of the donor, wherein the donation pledge includes payment account information, receiving, by the financial institution computer system, a request for the funds from the donee via a banking device provided by the financial institution computer system, wherein the request includes donee identification information, verifying, by the financial institution computer system, the identity of the donee based on the donee identification information, and transferring, by the financial institution computer system, the funds from the payment account of the donor to the donee via the banking device and based on the payment account information.

### BACKGROUND

After a disaster or other emergency has occurred (e.g., hurricane, flood, earthquake, hazardous material spill, transportation accident, etc.), relief is often needed at the site of the emergency. For example, persons within the affected area may require various supplies, including food, water, and other goods. In many instances, the affected persons may also require funds (e.g., cash) in order to pay for medical treatment, additional supplies, repairs to damaged property, and other costs. However, as a result of the emergency, the affected persons may not have access to their financial accounts. Thus, the affected persons may not have access to their own funds, and it may be difficult for a donor to provide relief funds directly to an affected person. Relief donations are often collected from multiple donors by a single organization and distributed at the discretion of the organization. However, the donors are unable to determine how the donated funds are used, or the percentage of donated funds that reach the affected (e.g., intended) person(s).

### SUMMARY

One embodiment of the present disclosure relates to a computer-implemented method performed by one or more processors of a financial institution computer system. The method includes receiving, by the financial institution computer system, a donation pledge from a donor to send funds to a donee from a payment account of the donor, wherein the donation pledge includes payment account information, receiving, by the financial institution computer system, a request for the funds from the donee via a banking device provided by the financial institution computer system, wherein the request includes donee identification information, verifying, by the financial institution computer system, the identity of the donee based on the donee identification information, and transferring, by the financial institution computer system, the funds from the payment account of the donor to the donee via the banking device and based on the payment account information.

Another embodiment of the present disclosure relates to a computer-implemented method performed by one or more processors of a financial institution computer system. The method includes receiving, by the financial institution computer system, a donation pledge from a donor to provide funds from a payment account of the donor to an emergency relief effort, wherein the donation pledge includes payment account information, determining, by the financial institution computer system, residency requirements for receiving relief associated with the emergency relief effort, receiving, by the financial institution computer system, a request for funds associated with the emergency relief effort from a requesting party via a banking device provided by the financial institution computer system, wherein the request includes identification information for the requesting party, verifying, by the financial institution computer system, that the requesting party is an eligible donee based on the identification information, including verifying that the requesting party meets the residency requirements, and based on verification of the requesting party, transferring, by the financial institution computer system, at least a portion of the funds from the payment account of the donor to the requesting party via the banking device.

Another embodiment of the present disclosure relates to a computer-implemented method performed by one or more processors of a financial institution computer system. The method includes receiving, by the financial institution computer system, a donation pledge from a donor to provide a product to an emergency relief effort, wherein the donation pledge includes account information for a payment account of the donor, determining, by the financial institution computer system, a merchant to provide the donated product based on the product and the emergency relief effort, determining, by the financial institution computer system, residency requirements for receiving the donated product based on the emergency relief effort, purchasing, by the financial institution computer system, the product by transferring funds from the payment account of the donor to an account of the merchant as payment for the product, receiving, by the financial institution computer system, a request for the donated product from a requesting party via a POS device of the merchant, wherein the request includes identification information for the requesting party, verifying, by the financial institution computer system, that the requesting party is an eligible donee based on the identification information, including verifying that the requesting party meets the residency requirements, and based on verification of the requesting party, authorizing, by the financial institution computer system, release of the donated product to the requesting party.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a schematic diagram of an emergency relief disbursement system, according to an example embodiment.

FIG. 2 is a schematic flow diagram of a process that may be implemented using the system shown in FIG. 1, the process including facilitating an emergency relief donation from a donor to a designated donee, according to an example embodiment.

FIG. 3 is a schematic flow diagram of a process that may be implemented using the system shown in FIG. 1, the process including facilitating an emergency relief donation from a donor to an identified relief effort, according to an example embodiment.

FIG. 4 is a schematic flow diagram of a process that may be implemented using the system shown in FIG. 1, the process including facilitating the purchase of a product by a donor and providing the purchased product to a donee via a merchant, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

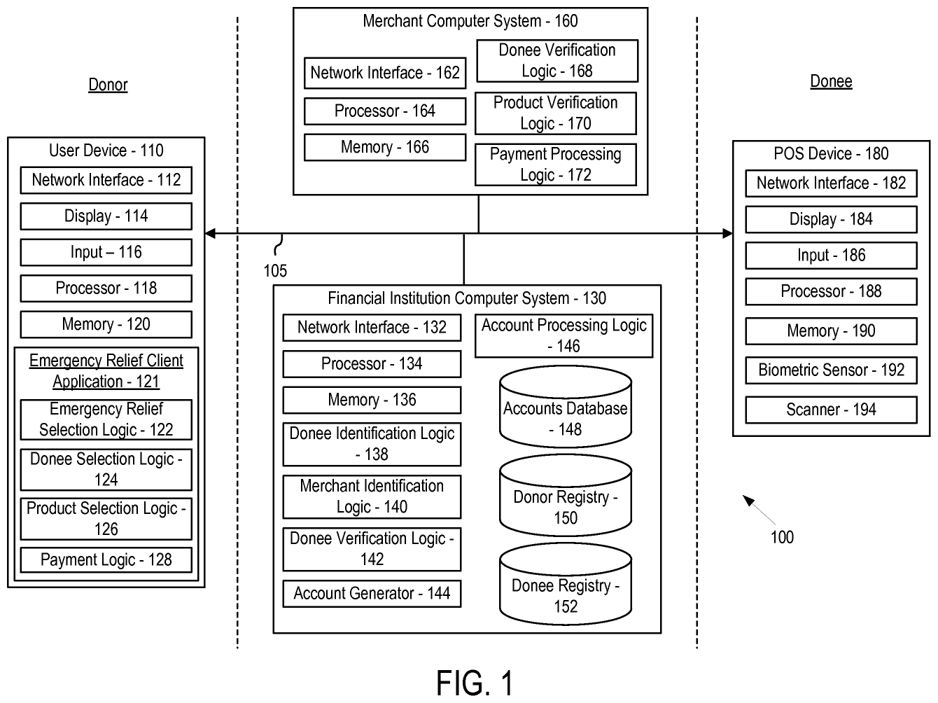

Referring to FIG. 1, an emergency relief disbursement system 100 is shown, according to an example embodiment. The emergency relief disbursement system 100 may be used to facilitate an emergency relief donation (e.g., funds, purchased goods) from a donor to an affected person (i.e., a donee). Using the emergency relief disbursement system 100, the donor selects an emergency relief effort and provides payment account information to a financial institution. The financial institution may then transfer an associated donation payment, or a corresponding amount of purchased goods, to an eligible donee based on the selected emergency relief effort and the payment account information provided by the donor. The financial institution may also utilize information provided by the donor and the donee to verify the donee prior to distributing the donation to the payee.

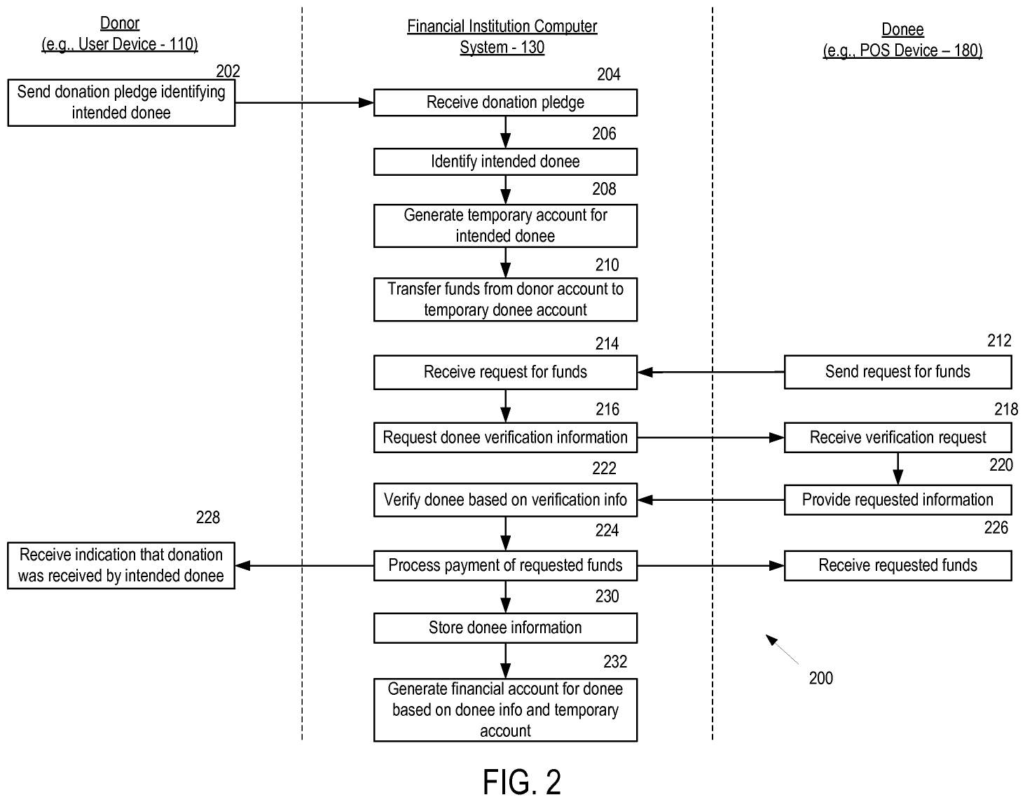

The emergency relief disbursement system 100 may include, among other systems, a user device 110, a financial institution computer system 130, merchant computer system 160, and a point-of-sale (POS) device. The systems may each be owned and operated by a separate entity. Two or more systems may also be combined to operate as a single system, or two or more systems may be owned or operated by a single entity. For instance, the POS device 180 may be operated by either the financial institution computer system 130 or the merchant computer system 160 to facilitate any functions of the respective system that are described herein. The systems may include a computer system (e.g., one or more servers each with one or more processing circuits) configured to execute instructions, send and receive data stored in memory, and perform other operations to implement the operations described herein or associated with logic or processes shown in FIGS. 2 through 4.

The user device 110, the financial institution computer system 130, the merchant computer system 160, and the POS device 180 each include a processor and memory. The processor may be implemented as application specific integrated circuits (ASICs), one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and non-transitory computer storage media. The memory may include data base components, object code components, script components, or any other type of information structure for supporting the various activities and information structures described herein. The memory may be communicably connected to the processor and include computer code or instructions for executing one or more processes described herein.

The user device 110, the financial institution computer system 130, the merchant computer system 160, and the POS device 180 may communicate through a network 105. The network 105 may be a single communication network configured to communicatively connect each of the systems, or the network 105 may include a plurality of networks each connecting two or more systems. The network 105 may be a wired or wireless network, including one or more of the Internet, a cellular network, Wi-Fi, Wi-Max, a proprietary banking network, and so on.

The user device 110 may be used by an individual user (e.g., a donor) to access the network 105 and communicate with the other computer systems shown in FIG. 1. The user device 110 may be, for example, a cellular phone, smart phone, mobile handheld wireless e-mail device, personal digital assistant, portable gaming device, tablet, laptop, or other suitable device configured to access the network 105. The user device 110 may also include automated banking machine (ATM) or other banking device that is located at a financial institution location and configured to access the network 105, or to otherwise communicate with the financial institution computer system 130. In an example embodiment, the user of the user device 110 is a donor wishing to make a donation via the financial institution computer system 130 to one or more persons requiring emergency relief.

The user device 110 includes a network interface 112, display 114, and an input 116. The network interface 112 may be a wireless network interface that communicates with a wireless communication protocol (e.g., 802.11a/b/g/n, Bluetooth®, ZigBee®, CDMA, GSM, LTE, WiMax, etc.). The network interface 112 may include, for example, program logic that connects the user device 110 to the network 105. As described in greater detail below, the user device 110 may receive and display screens prompting the user to provide information relating to a requested donation. Such screens are presented to the user via the display 114. The input 116 may be used to permit the user to provide the requested information. In some arrangements, the display 114 and input 116 are integrated in a touchscreen display. As will be appreciated, in addition to or instead of the user device 110, users may also be provided with the ability to access the emergency relief disbursement system 100 using another type of computer (e.g., a desktop or laptop computer executing browser software, a device provided by the financial institution, etc.) to perform the operations described herein as being performed by the user device 110. In still other embodiments, the donor may otherwise communicate the required information to the financial institution computer system 130, such as in-person or by phone via an agent of the financial institution.

The user device 110 also includes a processor 118 and memory 120. The memory 120 includes programming modules and logic that, when executed by the processor 118, control the operation of the user device 110. For instance, the user device 110 also includes an emergency relief client application 121, which may be stored on the memory 120. The emergency relief client application 121 may comprise program logic executable by the user device 110 to implement at least some of the functions described herein. The emergency relief client application 121 can refer to any application or web interface provided to the user via the emergency relief disbursement system 100, which may include an application or web interface provided by the financial institution computer system 130 or the merchant computer system 160. As will be appreciated, the level of functionality that resides on the user device 110 as opposed to the providing system (e.g., financial institution computer system 130, merchant computer system 160) may vary depending on the implementation.

In an example embodiment, the emergency relief client application 121 is provided by the financial institution computer system 130 and facilitates communication between the user and the financial institution computer system 130. In this embodiment, the user may request to make a donation, including providing any required information to the financial institution computer system 130, using the emergency relief client application 121. The financial institution computer system 130 may also request information from the user and provide updates regarding the status of a particular donation using the emergency relief client application 121. If the user holds a financial account provided by the financial institution computer system 130, the emergency relief client application 121 may be included as part of a mobile banking application provided by the financial institution computer system 130. The mobile banking application may be configured to allow the user to securely access an online banking website of the financial institution to interact with various accounts held by the user. For instance, the functions of the emergency relief disbursement system 100 described herein may be utilized by accessing an “emergency relief donation” area of the mobile banking site or application. The mobile banking application may also enable the user to perform various other tasks or functions that could otherwise be performed using the financial institution website, or at a branch location.

In the illustrated embodiment of FIG. 1, the emergency relief client application 121 includes emergency relief selection logic 122, donee selection logic 124, product selection logic 126, and payment logic 128, which may be executed to perform various functions of the emergency relief client application 121. The emergency relief selection logic 122 enables the user to identify (e.g., select) an emergency relief effort to which the user intends to donate. The emergency relief selection logic 122 may, for instance, enable the user to select an emergency relief effort from a list provided by the financial institution computer system 130. The user may also be able to search for a particular emergency relief effort from a database provided by the financial institution computer system 130.

Similarly, the donee selection logic 124 enables the user to identify an intended donee for the donation. The user may identify the donee by selecting the donee from a provided list (e.g., a list of account holders at the financial institution, a donee registry, a list of residents within the affected area, etc.). The user may also identify the donee by providing information related to the donee, including the name, address, personal identification number, or other identifying information. The identifying information may be utilized to verify the identity of the donee prior to releasing the donation. For instance, the donor may provide a challenge question and answer using the donee selection logic 124. The challenge question may then be used to verify the donee prior to providing the donation to the donee. If a specific donee is not selected by the donor, the donation may be added to a general fund or made available to one or more eligible donees residing within the affected area.

The product selection logic 126 enables the user to select a product to be purchased and donated to the donee. The user may select a category of product (e.g., canned goods, bottled water, soap, etc.) or a particular product to be purchased (e.g., by brand name). The product may be selected from a list of products that are available at a participating merchant within or near the affected area. The payment logic 128 enables the user to provide payment details for the donation. For instance, the payment logic 128 may enable the user to select a payment account (e.g., a financial account provided by the financial institution computer system 130, a payment provider account, an account at another financial institution) from which the donation will be provided. The payment logic 128 may also facilitate providing account information for the selected payment account, including any information required to enable the financial institution computer system 130 to access the pledged funds. The payment logic 128 may also be used to specify a payment amount for the donation.

Referring still to FIG. 1, the financial institution computer system 130 includes a network interface 132 that enables the financial institution computer system 130 to communicate data to and from the other devices and systems described herein (e.g., the user device 110, the merchant computer system 160, the POS device 180, etc.) via the network 105. The network interface 132 may include, for example, program logic that connects the financial institution computer system 130 to the network 105. The financial institution computer system 130 also includes a processor 134 and memory 136. The memory 136 stores programming modules (e.g., logic) that, when executed by the processor 134, control the operation of the financial institution computer system 130. For instance, the financial institution computer system 130 includes donee identification logic 138, merchant identification logic 140, donee verification logic 142, account generator 144, and account processing logic 146. Such logic may be implemented in a machine (e.g., one or more networked computer servers) comprising machine-readable media (e.g., memory 136) having instructions stored therein which are executed by the machine to perform the operations described herein.

The donee identification logic 138 may be executed to determine an intended donee based on the donation request (i.e., donation pledge) received from the user (i.e., the donor). The donee identification logic 138 may be configured to identify the intended donee based on the donee information provided by the donor, including a name, address, personal identification number, telephone number, or a unique identifier. The donee identification logic 138 may also consult a database or registry having other information related to the donee in order to identify the intended donee. For instance, the donee identification logic 138 may be utilized to match the provided donee information to stored information relating to a person. Once the match is found, the donee identification logic 138 may consult other stored information related to the person to determine the identity of the person (i.e., the intended donee). Any information that is found may be stored (e.g., in the donee registry) by the financial institution computer system 130. The stored information may then be used to verify the identity of the donee prior to disbursing the funds. As an example, if the intended donee has an account provided by the financial institution computer system 130, the donee identification logic 138 may access a stored database (e.g., accounts database 148) to match the identifying information to an intended donee. If the intended donee is not an account holder, the donee identification logic 138 may access another available database or registry (e.g., credit reports, DMV registry, a social networking profile, etc.) to match the identifying information to the stored information.

In some embodiments, the user does not specify an intended donee, identifying only a particular emergency relief effort in the donation request. In these embodiments, the donee identification logic 138 is configured to identify one or more eligible donees based on the emergency relief effort. The eligible donees may be those that have been affected by the associated emergency. For instance, the donee identification logic 138 may identify a particular geographic area that is affected by the emergency and make eligible all residents within the affected area. The affected area may be determined based on a distance from the epicenter of the emergency. The eligible donees may be identified as all persons having a home, work, and/or other address within a specified radius of the epicenter. The eligible donees may also be identified as all persons having residency within a particular city or other identified region (e.g., county, state, country, etc.), or those persons residing within a particular zip code.

The merchant identification logic 140 may be executed to determine a merchant provider to provide a donated product. In some embodiments, the donor requests to donate a product to a donee. The product may be purchased from a merchant location within or near the affected area using funds from a payment account of the donor. The purchased product may then be provided to eligible donees at the merchant location. In these embodiments, the merchant identification logic 140 identifies the merchant provider (e.g., a merchant location) to provide the purchased product based on availability of the selected product and proximity of the merchant provider to the affected area. The merchant identification logic 140 may also determine the merchant provider based on an existing relationship between the merchant (i.e., the merchant computer system 160) and the financial institution computer system 130. In an example embodiment, the merchant identification logic 140 selects a merchant provider that is within the affected area, sells the selected product, and is configured to communicate with the financial institution computer system 130 via the network 105.

The donee verification logic 142 may be executed to verify (i.e., validate) the identification of the requesting party (i.e., the donee) prior to the donated funds being made available to the donee. The donee verification logic 142 may verify the identity of the donee based on a photo ID, such as a driver's license, a bank card or a mobile device having stored identification information. If the requesting party does not have access to a driver's license or bank card, or if the cellular networks are non-operational, the donee verification logic 142 may also verify the identity of the requesting party by matching information received from the requesting party with known donee information. For instance, if the donee has an account provided by the financial institution computer system 130, the donee verification logic 142 may match information received from the requesting party with stored donee information related to the provided account. The information may include contact information, account information, biometric data, and other personal identifying information. If the donee does not have an account provided by the financial institution computer system 130, the donee verification logic 142 may verify the identity of the donee by matching information received from the requesting party with donee information that was provided by the donor as part of the donation request. In this embodiment, the donee verification logic 142 may also verify the identity of the donee by matching information received from the requesting party with personal identifying information retrieved from other data that is accessible by the financial institution computer system 130, including credit reports, DMV registration information, census information, and any public listings.

When all persons within an affected area are eligible to receive the donation, the donee verification logic 142 may verify the identity of the requesting party by verifying that the person's home address is within the affected area. The home address of the requesting party may be verified based on a government-issued photo ID (e.g., a driver's license) or another similar document having the party's residential address. If such articles are not available, the donee verification logic 142 may also verify the person is eligible by matching information received from the requesting party with known information corresponding with a person having a residence within the affected area (i.e., thus verifying that the person resides within the affected area). This information may be available from a public registry.

Prior to allowing the requesting party to access the donation, the donee verification logic 142 may also verify that the person has not previously received a donation (i.e., where only one withdrawal per person is allowed). The donee verification logic 142 may also verify that the person has not reached a maximum allotment of donated funds (i.e., where a limited amount of funds are available per person).

The account generator 144 may be executed to generate a financial account for a donor or a donee. The account is generated based on information received from the donor or donee. For instance, if the donee does not have an account with the financial institution computer system 130, the account generator 144 may generate a temporary account for the donee to store any donated funds intended for the donee. The temporary account may be generated based on donee information received from the donor and/or the donee. The temporary account may be dissolved once the funds are withdrawn. The account generator 144 may also generate a fully functional financial account provided by the financial institution computer system 130 based on the temporary account. The account generator 144 may request and/or receive any additional information from the donee that is required to establish the financial account. Any funds from the temporary account may then be transferred to the generated financial account. Similarly, the account generator 144 may also generate one or more accounts for the donor based on information received from the donor.

The account processing logic 146 may be executed to process the requested donation. The account processing logic 146 is configured to access a payment account of the donor based on account information provided by the donor. The account processing logic 146 may be configured to transfer funds from the donor financial account to the appropriate party upon verifying the identity of the intended donee. For instance, the account processing logic 146 may debit the donor financial account by the donation amount when the donation request is received from the donor, storing the donation amount in a temporary account. When the donation pledge includes a cash donation, the account processing logic 146 may transmit the payment to the POS device 180 for cash payment to the donee upon verifying the identity of the donee. When the donation pledge includes a product, the account processing logic 146 may transmit the payment amount to an account of the merchant (i.e., the merchant computer system 160) upon verifying the identity of the donee at the merchant (i.e., at the POS device 180). The purchased product may then be available to a verified donee.

The financial institution computer system 130 also includes an accounts database 148 configured to store information (i.e., user financial data) that is related to any of the one or more financial accounts provided by the financial institution. The accounts database 148 may also include information related to the owners of the account (i.e., the account holder), including information related to the donor and the donee. Information stored within the accounts database 148 may be utilized to verify the donee prior to processing the donation payment.

The financial institution computer system 130 also includes a donor registry 150 and a donee registry 152. Information that is received and related to the donor is stored in the donor registry 150. The donor registry 150 may be utilized to track any persons or entities that have contributed to a relief effort. The donor information may be utilized to contact the donor, such as to offer a financial account to the donor. Similarly, information that is received and related to a donee is stored in the donee registry 152. The donee registry 152 may be utilized to track any persons or entities that have received donated funds or products. Temporary accounts for the donees may be generated utilizing information stored in the donee registry 152. This information may also be utilized to verify the intended donee. The donee information may also be utilized to contact the donee, such as to offer a financial account to the donee. The information stored within the donor registry 150 and donee registry 152 may include personal identifying information, account information, biometrics, social media information (e.g., usernames, groups, networks), as well as any other information required for Know Your Customer (KYC) and Customer Identification Program (CIP) regulations.

The merchant computer system 160 is operated by a merchant that is within or proximate an area requiring emergency relief (i.e., an affected area). In some embodiments, the merchant computer system 160 is configured to provide a product to an intended donee in exchange for payment for the product by the payor. The merchant computer system 160 includes a network interface 162 that allows the merchant computer system 160 to communicate data to and from the other devices and systems described herein (e.g., financial institution computer system 130, POS device 180) via the network 105. The network interface 162 may include, for example, program logic that connects the merchant computer system 160 to the network 105. The merchant computer system 160 also includes a processor 164 and memory 166. The memory 166 stores programming modules that, when executed by the processor 164, control the operation of the merchant computer system 160. For instance, the merchant computer system 160 includes donee verification logic 168, product verification logic 170, and payment processing logic 172. Such logic may be implemented in a machine (e.g., one or more networked computer servers) comprising machine-readable media (e.g., memory 166) having instructions stored therein which are executed by the machine to perform the operations described herein.

The donee verification logic 168 is similar to the donee verification logic 142 and may be executed to verify (i.e., validate) the donee prior to a donated product being made available to a donee. The donee verification logic 168 may verify a person requesting a donated product by matching information received from the person with information related to the intended donee. For instance, when a donee is identified by the donor in the donation request, the donee verification logic 168 may verify the identity of a person requesting a purchased product by matching information received from the person with known donee information (e.g., information previously provided by the donor). The information from the donation request may be received by the merchant computer system 160 from the financial institution computer system 130 in order to verify an intended donee. When all persons within an affected area are eligible to receive the donated product, the donee verification logic 168 may verify the identity of the person by verifying a home address of the person is within the affected area (e.g., based on a photo ID).

The donee verification logic 168 may also verify that the person has not previously received one of the donated products (i.e., where only one product per person is provided). The donee verification logic 168 may also verify that the person has not reached a maximum allotment of the donated product (i.e., where limited amount(s) are available per person). When the person is verified as an intended donee, the donee verification logic 168 may provide an indication to the financial institution computer system 130. In other embodiments, the donee verification logic 168 may simply send information received from the requesting party to the financial institution computer system 130 for verification by the donee verification logic 142. The donee verification logic 168 may also request any additional information that is required from the party requesting the purchased product via the POS device 180.

The product verification logic 170 may be executed to identify the product that is purchased by the donor and verify that the same product is being requested by the donee. The product verification logic 170 identifies the purchased product based on the donation request or other information provided by the financial institution computer system 130. For instance, the financial institution computer system 130 may send a notification to the merchant identifying the purchased product. The product verification logic 170 matches the product requested by a donee based on information received via the POS device 180. For instance, the POS device 180 may receive information from a barcode located on the product (e.g., using scanner 194). The product verification logic 170 may be utilized to verify the product is the intended purchased product based on the barcode information.

The payment processing logic 172 may be executed to process the donation payment received from the donor. Once the donee and the product are verified (e.g., by the merchant computer system 160, by the financial institution computer system 130), the payment processing logic 172 receives the donation payment amount from the financial institution computer system 130 and deposits in an account of the merchant.

The POS device 180 may be used to access the network 105 and communicate with the other computer systems shown in FIG. 1. The POS device 180 may be operated by the financial institution computer system 130 or the merchant computer system 160 and utilized to communicate with the donee. The POS device 180 includes a network interface 182, display 184, and an input 186. The network interface 182 may be a wireless network interface that communicates with a wireless communication protocol (e.g., 802.11a/b/g/n, Bluetooth®, ZigBee®, CDMA, GSM, LTE, WiMax, etc.). The network interface 182 may include, for example, program logic that connects the POS device 180 to the network 105. As described in greater detail below, the POS device 180 may receive and display screens prompting the user (e.g., the donee, the merchant) to provide information relating to a requested donation, and in particular the donee. Such screens are presented to the user of the POS device 180 via the display 184. The input 186 may be utilized by the user to provide the requested information. In some arrangements, the display 184 and input 186 are integrated in a touchscreen display.

In one embodiment, the POS device 180 is operated by the financial institution computer system 130. For instance, the POS device 180 may be an ATM or other banking device that is located at or near the affected area and configured to access the network 105, or to otherwise communicate with the financial institution computer system 130. In this embodiment, the ATM may be powered by a generator and configured to communicate with the network 105 and/or the financial institution computer system 130 by cellular or satellite signal. The POS device 180 may be utilized by the donee to request funds intended for the donee, including providing any information required to verify the identity of the donee. The POS device 180 may also be utilized by the financial institution computer system 130 to provide prompts to the donee, including requests for additional information.

In another embodiment, the POS device 180 is operated by the merchant computer system 160. For instance, the POS device 180 may be a cash register or other POS terminal located at the merchant provider location and configured to access the network 105, or to otherwise communicate with the merchant computer system 160. In this embodiment, the POS device 180 may be operated by an agent of the merchant and/or the donee to request a product purchased by the donor and intended for the donee. As an example, the POS device 180 may be utilized to provide any information required to verify the identity of the donee. The POS device 180 may also be utilized by the merchant computer system 160 to verify the product and the donee, as well as to provide prompts to request additional information from the donee.

The POS device 180 may be, for example, a cellular phone, smart phone, mobile handheld wireless e-mail device, personal digital assistant, portable gaming device, tablet, laptop, or other suitable device configured to access the network 105. The user device 110 may also include automated banking machine (ATM) or other banking device that is located at a financial institution location and configured to access the network 105, or to otherwise communicate with the financial institution computer system 130. In an example embodiment, the user of the user device 110 is a donor wishing to make a donation via the financial institution computer system 130 to one or more persons requiring emergency relief.

The POS device 180 also includes a processor 188 and memory 190. The memory 190 includes programming modules and logic that, when executed by the processor 188, control the operation of the POS device 180. The POS device 180 also includes a biometric sensor 192 configured to receive biometric information related to the donee. The biometric sensor 192 includes any type of sensor configured to collect physiological characteristics (e.g., body shape, fingerprint, face recognition, DNA, palm print, hand geometry, iris recognition, retina characteristics, scent, etc.), behavioral characteristics (e.g., typing rhythm, gait, voice characteristics, etc.), or other available biometric information. For example, the biometric sensor 192 may include a camera, scanner, microphone, or other type of sensor configured to collect the biometric data described. The biometric data collected by the POS device 180 may be used to verify the identity of the donee. Any information collected may be stored in the donee registry 152. The POS device also includes a scanner 194 or other optical reader that is configured to read information stored in an optical representation of data (e.g., a barcode). For instance, a barcode may be provided on a product and the product may be verified as a purchased product based on the information stored within the barcode. As will be appreciated, the level of functionality that resides on the POS device 180 as opposed to the providing system (e.g., financial institution computer system 130, merchant computer system 160, etc.) may vary depending on the implementation.

Referring now to FIGS. 2-4, processes 200, 300, and 400 are shown for facilitating an emergency relief donation to an affected person. The processes 200, 300, and 400 may be performed using the emergency relief disbursement system 100 shown in FIG. 1. In particular, the processes 200, 300, and 400 may be performed using any or all of the user device 110, the financial institution computer system 130, the merchant computer system 160, and the POS device 180, including any logic or other components of the systems and devices that are described in further detail herein. In some embodiments, the steps of processes 200, 300, and 400 that are shown and described as being performed by one of the financial institution computer system 130 and the merchant computer system 160 may be performed by the other of the financial institution computer system 130 and the merchant computer system 160, depending on the particular application.

Referring particularly to FIG. 2, process 200 is shown for facilitating a donation from a donor to a donee, according to an example embodiment. At 202 of the process 200, the donor (e.g., via the user device 110) sends a donation request to the financial institution computer system 130. The request may be sent using the emergency relief client application 121. The donation request includes selection of an emergency relief effort, a payment amount for the donation, and identification of a donor payment account. The donor payment account may be an account provided by the financial institution computer system 130. If the donor payment account is not provided by the financial institution computer system 130, the donation request may include payment account information sufficient for the financial institution computer system 130 to access the donor payment account and receive the payment amount for the donation.

The donation request also includes identification of an intended person to receive the funds (i.e., the intended donee). The donee identification may include identifying information for the donee, including information intended to be used to verify the intended donee. For instance, the donee information may include a challenge question to be answered by the donee in order to verify the identity of the donee. The challenge question may include personal identification information of the donee, such as a social security number, date of birth, or driver's license number. The challenge question may also be related to any other information that is known to only the donor and the donee. At 204, the donation request is received by the financial institution computer system 130.

At 206, the financial institution computer system 130 identifies the intended donee. The intended donee may be identified based on information received from the donor as part of the donation request. For instance, the financial institution computer system 130 may identify the intended donee by matching any donee information provided by the donor to information stored in accounts database 148, donor registry 150, donee registry 152, or another database or registry accessible by the financial institution computer system 130. Any information matched to the provided donee information may be compiled and stored by the financial institution computer system 130.

At 208, the financial institution computer system 130 generates a temporary account (i.e., pseudo-account) for the intended donee based on the donee information. The temporary account is provided for a limited use. For instance, the temporary account may be dissolved when the donation amount is transmitted to the donee. The temporary account may be stored in the accounts database 148. In an example embodiment, the temporary account only allows withdrawals by the donee, and no other functionality. At 210, the financial institution computer system 130 transfers funds (i.e., the donation amount) from the payment account specified by the donor to the temporary account of the donee. In other embodiments, such as when the financial institution computer system 130 provides the selected payment account, the financial institution computer system 130 may merely put a hold on the donation amount rather than move the donation amount to a temporary account. In this embodiment, the donor is prohibited from accessing the donation amount until the donation is processed.

At 212, the donee sends a request for donation funds to the financial institution computer system 130 using the POS device 180. In this embodiment, the POS device 180 may be a mobile ATM stationed at or near the affected area. The request may include information identifying the donee. For instance, the POS device 180 may be utilized to scan the donee's driver's license (or other personal identification card) and send the information (e.g., the image) to the financial institution computer system 130 with the request. The request may also include any biometric information of the donee provided via the POS device 180.

At 214, the financial institution computer system 130 receives the request for funds. At 216, the financial institution computer system 130 requests donee verification information from the donee (i.e., sends a request for additional information to the POS device 180). The financial institution computer system 130 may send the request for additional information when there has not been enough information provided to verify the donee. The request for additional information may include a request for any information that was provided by the donor or is otherwise accessible by the financial institution computer system 130 (e.g., stored in database 148 or registries 150, 152). For instance, the request for additional verification information may include a challenge question posed by the donor. In one embodiment, the financial institution computer system 130 provides two or more options to verify the identity of the donee, which may include any of the donee information described herein.

At 218, the donee (i.e., the POS device 180) receives the verification request from the financial institution computer system 130. The verification request includes an indication of the information that is required to verify the identity of the donee and process the donation payment. In one embodiment, the donee is provided with two or more verification options. For instance, a first option may be to scan the donee's photo identification card. However, if the donee does not have access to a photo identification card, the donee may select a second option (e.g., answer challenge question, provide social security number, etc.) in order to verify the donee's identity. At 220, the donee sends the requested verification information to the financial institution computer system 130 via the POS device 180. Again, the verification information may include an answer to the challenge question, biometric data, or any of the other donee information described above. At 222, the financial institution computer system 130 verifies the donee based on the verification information received from the donee. The donee may be verified by matching the challenge question answer to the answer provided by the donor within the donation request. The donee may also be verified by matching any other information received as part of the verification information to information previously known about the donee.

Upon verifying the identity of the donee, at 224 the financial institution computer system 130 processes the donation payment and provides the funds to the payee. For instance, the financial institution computer system 130 may provide the donee with credentials for the temporary account in order to access the donation. The financial institution computer system 130 may also cause the POS device 180 to disperse cash to the donee. In one embodiment, the financial institution computer system 130 provides a portion of the donation payment amount via cash and also provides credentials for the temporary account in order to access the remaining amount. At 226, the donee receives the requested funds. At 228, the financial institution computer system 130 provides an indication to the donor (e.g., the user device 110) that the donation was received by the intended donee. The indication may be received by the donor using the emergency relief client application 121. The financial institution computer system 130 may also indicate a percentage of the specified donation payment amount was received by the intended donee, a timestamp for receipt of the funds, and location information related to receipt.

At 230, the financial institution computer system 130 stores the information received from the donee in the donee registry 152. The stored information may be utilized to offer a financial account to the donee. The stored information may also be utilized to verify a future donation. At 232, the financial institution computer system 130 generates a financial account for the donee based on the donee information. The financial institution computer system 130 may be generated based on a request received from the donee. Prior to generating the financial account, the financial institution computer system 130 may request any additional information that is required to generate the financial account, including any information required by KYC or CIP regulations. The generated financial account may also be based on the temporary account. For instance, any funds remaining in the temporary account may be automatically transferred to the generated financial account and the temporary account dissolved. The user (i.e., donee) credentials associated with the temporary account may also be utilized to access the generated financial account. The generated financial account, as well as any information related to the donee and/or the new account may be stored in the accounts database 148.

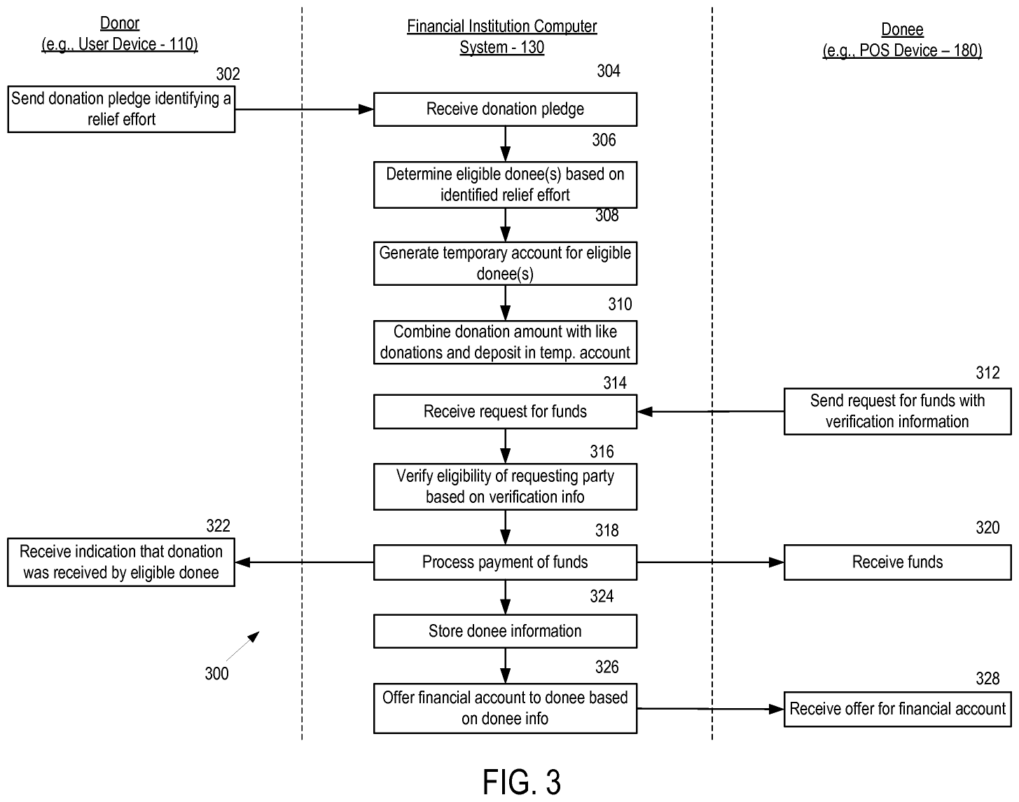

Referring now to FIG. 3, process 300 is shown for facilitating an emergency relief donation from a plurality of donors to an identified relief effort, according to an example embodiment. At 302 of the process 300, a donor sends (e.g., via the user device 110) a donation pledge to the financial institution computer system 130. This step is substantially similar to 202 of process 200. However, in this embodiment, the donor does not identify an intended donee. The donation pledge includes a payment amount, payment account details of the donor, and identification of an emergency relief effort (e.g., “Example” Earthquake Fund). At 304, the financial institution computer system 130 receives the donation pledge.

At 306, the financial institution computer system 130 determines the eligible donees based on the identified emergency relief effort. The financial institution computer system 130 may determine eligible donees based on the identified relief effort when the donor does not identify an intended donee within the donation pledge. In an example embodiment, the financial institution computer system 130 determines that only persons residing within the geographic area affected by the associated emergency or disaster (i.e., eligible donees) are eligible to receive a portion of the payment amount. The affected area may be determined based a destruction radius associated with the emergency. For instance, factors may include accessibility of electricity or running water, damage to public health facilities, damage to transportation structures, or any other similar measure.

At 308, the financial institution computer system 130 generates a temporary account for the eligible donees (i.e., for the identified emergency relief effort). The temporary account is shown as being generated after the donation pledge is received from the donor, but the temporary account may be generated at any time after the emergency relief effort is organized. The temporary account may be at least partially accessible to eligible donees (e.g., accessible only to withdraw a predetermined amount of funds). At 310, the financial institution computer system 130 receives the donation payment amount from the payment account of the donor and deposits the payment amount in the temporary account. The funds are pooled (e.g., grouped, combined, etc.) with other donor funds intended to support the same emergency relief effort. Funds may then be distributed to eligible donees from the combined pool. The funds may be distributed equally amongst the eligible donees, or based on other factors.

In an example embodiment, the financial institution computer system 130 may store the funds in the temporary account (without disbursing to eligible donees) until a donation goal is reached. For instance, the financial institution computer system 130 may designate a sub-fund within the identified emergency relief fund to finance a particular relief project (e.g., re-building a school, repairing a water purification system, etc.). The financial institution computer system 130 may then collect donations from donors identifying the sub-fund until a donation goal (e.g., $100,000) is reached. When the goal is reached, the financial institution computer system 130 may disperse the funds to a person or entity associated with the sub-fund (e.g., a construction company contracted to re-build the school), dissolve the temporary account, and notify the donors that the goal was reached and the funds were dispersed. In another embodiment, the funds may be collected and stored in the temporary account for a designated time period (e.g., 24 hours, 1 week, etc.), during which eligible donees are invited to request the donated funds. At the end of the designated time period, the donated funds are then distributed equally amongst those eligible donees that requested funds within the designated time period. Once the funds are distributed, funds may then be collected for a second designated time period and dispersed in a similar fashion.

At 312, the donee sends (e.g., via the POS device 180) a request for funds to the financial institution computer system 130. The funds request may include information intended to identify the donee. The funds request may also include information intended to verify the residency of the donee. The donee may be required to provide various identifying information in order to send a funds request. In an example embodiment, the financial institution computer system 130 requires the donee, as part of a funds request, to provide information required to generate a financial account for the donee.

At 314, the financial institution computer system 130 receives the request for funds. The request may include verification information for verifying the eligibility of the requester (i.e., the donee). Acceptable verification information may include a driver's license with a home address or another document verifying the residency of the requester. The financial institution computer system 130 may also verify the residency of the requester based on non-residence related information received from the donee. For instance, the financial institution computer system 130 may access a database listing identifying information (e.g., name, social security number, personal identification number, taxpayer ID, etc.) for at least some of the residents within the affected area. In this embodiment, the residency of the requester may be verified by requesting other identifying information and matching the identifying information to an address within the affected area. The verification information may include a combination of two or more pieces of identifying information. At 316, the financial institution computer system 130 verifies the eligibility of the requesting party to receive the donated funds based on the verification information.

At 318, upon verifying the eligibility of the requesting party (i.e., the donee), the financial institution computer system 130 processes the payment of at least a portion of the funds from the temporary account to the eligible donee. The portion received by the donee may be determined based on the number of eligible donees, the household size of the donee, a location of the donee's residence within the affected area, or any other factors. At 320, the donee receives the determined funds via the POS device 180. For instance, the funds may be provided as a cash payment. At 322, the donor (i.e., at the user device 110) receives an indication from the financial institution computer system 130 that funds were received by an eligible donee from the combined emergency relief funds.

At 324, the donee information is stored. The donee information may include any information received from the donor or the donee. The donee information may also include any information retrieved from a database or registry by the financial institution computer system 130 and related to the donee. At 326, the financial institution computer system 130 offers a financial account to the donee based on the donee information received. Although the offer is shown in the process 300 as occurring after the funds have been dispersed to the donee, the offer may occur at any time during the process 300. The offer may be provided to the donee using the POS device 180. The offer may also be sent to the donee using contact information received as part of the process 300.

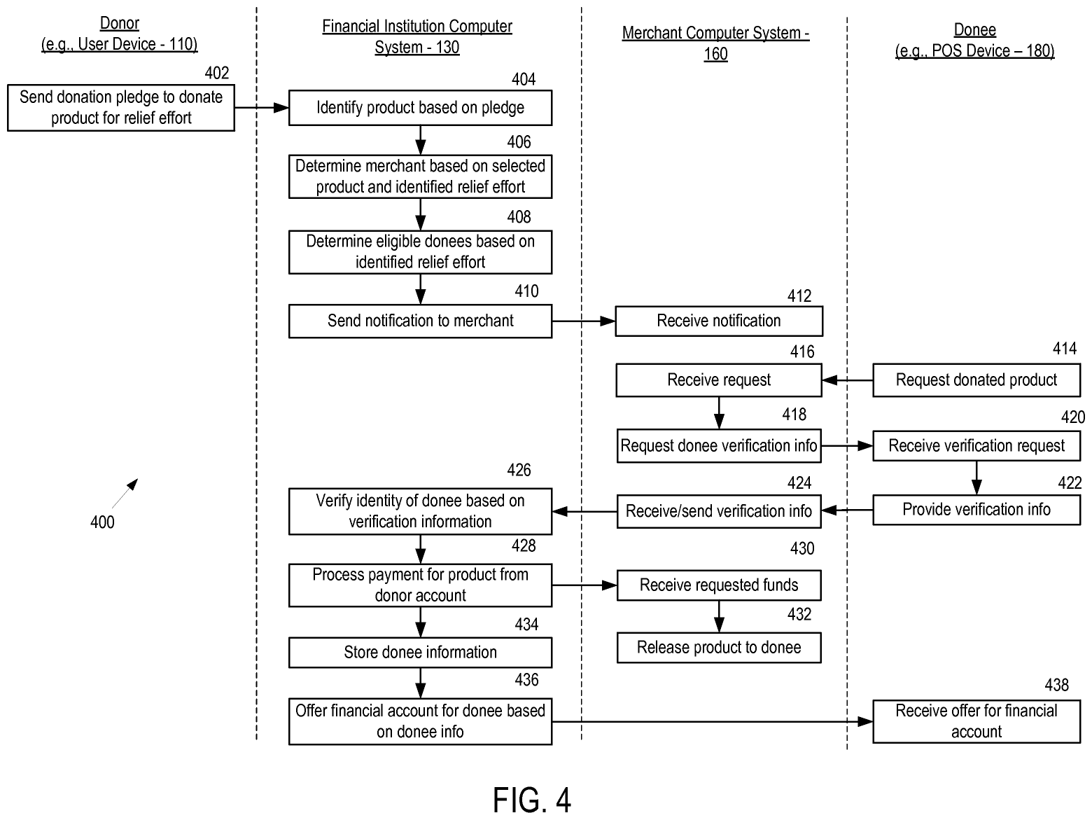

Referring now to FIG. 4, process 400 is shown for facilitating the purchase of a product by a donor and providing the purchased product to a donee via a merchant, according to an example embodiment. At 402 of the process 400, the donor sends (e.g., using the user device 110) a donation pledge to the financial institution computer system 130. The donation pledge includes a payment amount, payment account information for the donor, identification of a product to be purchased using the payment amount, and identification of the associated emergency relief effort. The product may be selected from a list of products provided by the financial institution computer system 130. The listed products may be determined by the financial institution computer system 130 based on products that are available at one or more eligible merchant locations. The eligible merchant locations may be selected based on proximity to the emergency relief location. The eligible merchant locations may also be selected based on an agreement between the financial institution computer system 130 and the merchant computer system 160. For instance, the financial institution computer system 130 may select only merchants that communicate with the financial institution computer system 130 via the network 105.

At 404, the financial institution computer system 130 identifies the donated product based on the donation pledge. For instance, if the donated product merely specifies a category of product (e.g., bottled water), the financial institution computer system 130 may communicate with the merchant computer system 160 to determine the availability of bottled water at merchant location(s) within or near the affected area. The particular donated product may be identified based on product availability and/or cost. At 406, the financial institution computer system 130 determines a merchant provider (e.g., a merchant location) for the donated product based on the identified product and emergency relief effort. For instance, the merchant provider may be selected based on availability of the identified product at a merchant location and proximity of the merchant location to the emergency relief effort. In an example embodiment, the selected merchant provider is located within the affected area and has inventory of the selected product to provide an amount of the selected product that corresponds with the amount of the donation.

At 408, the financial institution computer system 130 determines an eligible donee based on the donation pledge. The eligible donee(s) are determined in a manner similar to that described in relation to process 300. At 410, the financial institution computer system 130 sends a notification to the merchant computer system 160 that is associated with the merchant provider. The notification may include details of the donation pledge. The notification may also include a request to purchase the selected product. At 412, the merchant computer system 160 receives the notification from the financial institution computer system 130. In response to the notification, the merchant computer system 160 may provide a current inventory of the selected product. The merchant computer system 160 may also place a hold on the donated product based on the notification. The hold may ensure that the donated product is not sold, and is instead available to any eligible donees.

At 414, the donee requests the donated product from the merchant provider. The request may be received via a POS device 180 that is operated by the merchant provider. For instance, a barcode for the donated product may be scanned at the POS device 180 to initiate the request. The POS device 180 may be utilized by the requesting party to receive a donated product, including inputting information for verification purposes. In other embodiments, the POS device 180 is operated by an agent of the merchant. The request may include any required identification information for the requesting party (e.g., the donee). The identification information may include information required to verify that the requesting party is an eligible donee. The POS device 180 may be configured to receive identification information from the requesting party, including a scanned image of any identification documents and biometric data for the requesting party.

At 416, the merchant computer system 160 receives the request for the donated product. At 418, the merchant computer system 160 may request additional verification information from the requesting party via the POS device 180. At 420, the donee receives the verification request (e.g., at the POS device 180) from the merchant computer system 160. At 422, the requesting party provides the verification information to the merchant computer system 160 (e.g., via the POS device 180). At 424, the merchant computer system 160 receives the verification information from the requesting party. The merchant computer system 160 then sends the verification information to the financial institution computer system 130 to verify the requesting party.

At 426, the financial institution computer system 130 verifies that the requesting party is an eligible donee based on the received verification information. Upon verifying the requested party, the financial institution computer system 130 may authorize release of the donated product to the requesting party. In other embodiments, the merchant computer system 160 may verify the requesting party and send an indication to the financial institution computer system 130 that the requesting party has been verified. The financial institution computer system 130 may then authorize release of the donated product. At 428, the financial institution computer system 130 processes a payment for the product from the donor payment account to an account of the merchant computer system 160. At 430, the merchant computer system 160 (or an associated financial institution) receives the payment from the donor. The merchant computer system 160 may also receive a notification that the payment was made from the financial institution computer system 130. In other embodiments, the donated product may be purchased using the funds from the donor payment account prior to receiving the request for the donated product from the requesting party. In these embodiments, the donated product may be released to the requesting party immediately upon verification and/or authorization by the financial institution computer system 130.

At 432, the merchant computer system 160 releases the donated product to the donee. The product may be released to the donee upon verification of the identity of the requesting party. The product may also be released to the donee based on receipt of a corresponding payment from the donor. At 434, the financial institution computer system 130 stores (e.g., within the donee registry 152) any information related to the requesting party and received as part of the process 400. At 436, the financial institution computer system 130 offers a financial account to the requesting party based on the donee information. For instance, the stored information may include information to contact the requesting party in order to offer a financial account. At 438, the donee (i.e., the requesting party) receives the offer for a financial account. If the offer is accepted, the financial institution computer system 130 may generate a financial account for the requesting party and provide account credentials to the requesting party.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A computer-implemented method performed by one or more processors of a financial institution computer system, the method comprising:
receiving, by the financial institution computer system, a donation pledge from an application of a donor device to send funds to a donee from a payment account of a donor, wherein the donation pledge includes payment account information and donor-provided verification information;
receiving, by the financial institution computer system, a request for the funds from the donee via an automated teller machine (ATM) provided by the financial institution computer system, wherein the request includes donee identification information comprising biometric data collected via the ATM and donee-provided verification information;
verifying, by the financial institution computer system, the donee identification information by matching the biometric data to known information accessed via a database, the known information related to the donee and by matching the donee-provided verification information to the donor-provided verification information;
generating, by the financial institution computer system, a donee registry in the database based on the donee;
storing, by the financial institution computer system, the donee identification information within the donee registry in the database; and
transferring, by the financial institution computer system, the funds from the payment account of the donor to the donee via the ATM and based on the payment account information.

2. The method of claim 1, further comprising:
generating, by the financial institution computer system, a temporary account for the donee based on the donee identification information;
wherein transferring the funds includes:
depositing the funds in the temporary account; and
upon verifying the identity of the donee, sending the funds to the donee from the temporary account.

3. The method of claim 2, further comprising:
providing, by the financial institution computer system, a financial account to the donee based on the temporary account.

4-6. (canceled)

7. The method of claim 1, wherein the donation pledge includes personal identifying information for the donor, and further comprising offering, by the financial institution computer system, a financial account to the donor based on the personal identifying information and the payment account information.

8. The method of claim 1, further comprising, upon transferring the funds to the donee:
sending, by the financial institution computer system, a message to the donor indicating that the funds were received by the donee, including a percentage of the donated funds that were received by the donee and a timestamp for receipt.

9. A computer-implemented method performed by one or more processors of a financial institution computer system, the method comprising:
receiving, by the financial institution computer system, a donation pledge from an application of a donor device to provide funds from a payment account of a donor to an emergency relief effort, wherein the donation pledge includes payment account information;
determining, by the financial institution computer system, residency requirements for receiving relief associated with the emergency relief effort;
receiving, by the financial institution computer system, a request for funds associated with the emergency relief effort from a requesting party via a banking device provided by the financial institution computer system, wherein the request includes identification information for the requesting party comprising biometric data collected via the banking device;
verifying, by the financial institution computer system, that the requesting party is an eligible donee based on the identification information, including verifying that the requesting party meets the residency requirements, wherein the residency of the requesting party is verified by matching the biometric data to known information accessed via a database, the known information related to the requesting party;
generating, by the financial institution computer system, a donee registry in the database based on the requesting party;
storing, by the financial institution computer system, the requesting party information within the donee registry in the database; and
based on verification of the requesting party, transferring, by the financial institution computer system, at least a portion of the funds from the payment account of the donor to the requesting party via the banking device.

10. The method of claim 9, further comprising:
generating, by the financial institution computer system, a temporary account for the emergency relief effort; and
depositing, by the financial institution computer system, the funds from the payment account of the donor into the temporary account;
wherein the funds transferred to the requesting party are sent from the temporary account.

11. The method of claim 10, wherein the funds from the payment account are combined with donated funds from a second donor in the temporary account, and wherein the funds transferred to the requesting party include the funds received from the donor and the second donor.

12. The method of claim 9, further comprising:
offering, by the financial institution computer system, a financial account to the requesting party based on the identification information provided.

13. (canceled)

14. (canceled)

15. The method of claim 9, wherein the requesting party is verified by matching the identification information to known information that includes corresponding residency information for the requesting party.

16. The method of claim 9, wherein the donation pledge includes personal identifying information for the donor, and further comprising offering, by the financial institution computer system, a financial account to the donor based on the personal identifying information and the payment account information.

17. The method of claim 9, further comprising, upon distributing the funds provided by the donor:
sending, by the financial institution computer system, a message to the donor indicating that the funds were distributed, including a percentage of the funds that were distributed to eligible donees.

18. A computer-implemented method performed by one or more processors of a financial institution computer system, the method comprising:
receiving, by the financial institution computer system, a donation pledge from an application of a donor device to provide a product to an emergency relief effort, wherein the donation pledge includes account information for a payment account of a donor;
determining, by the financial institution computer system, a merchant to provide the donated product based on the product and the emergency relief effort;
determining, by the financial institution computer system, residency requirements for receiving the donated product based on the emergency relief effort;
purchasing, by the financial institution computer system, the product by transferring funds from the payment account of the donor to an account of the merchant as payment for the product;
receiving, by the financial institution computer system, a request for the donated product from a requesting party via a point-of-sale device of the merchant, wherein the request includes identification information for the requesting party comprising biometric data collected via the point-of-sale device;
verifying, by the financial institution computer system, that the requesting party is an eligible donee based on the identification information, including verifying that the requesting party meets the residency requirements, wherein the residency of the requesting party is verified by matching the biometric data to known information accessed via a database, the known information related to the requesting party;
generating, by the financial institution computer system, a donee registry in the database based on the requesting party;
storing, by the financial institution computer system, the identification information for the requesting party within the donee registry in the database; and
based on verification of the requesting party, authorizing, by the financial institution computer system, release of the donated product to the requesting party.

19. The method of claim 18, wherein the donation pledge includes a payment amount, and wherein purchasing the product includes purchasing a quantity of the product corresponding with the payment amount.

20. The method of claim 18, further comprising:
offering, by the financial institution computer system, a financial account to the requesting party based on the identification information provided.

21. (canceled)

22. (canceled)

23. The method of claim 18, wherein the requesting party is verified by matching the identification information to known information that includes corresponding residency information for the requesting party.

24. The method of claim 18, wherein the donation pledge includes personal identifying information for the donor, and further comprising offering, by the financial institution computer system, a financial account to the donor based on the personal identifying information and the payment account information.

25. The method of claim 18, further comprising, upon authorizing release of the donated product to the requesting party:
sending, by the financial institution computer system, a message to the donor indicating that the donated product was distributed to an eligible donee, including a timestamp.

26. The method of claim 18, further comprising:
generating, by the financial institution computer system, a temporary account for the donor based on the donation pledge;
depositing, by the financial institution computer system
wherein transferring the funds includes:
depositing the funds in the temporary account from the payment account of the donor; and
upon verifying the requesting party, sending the funds to the account of the merchant from the temporary account.
